(19) United States
(12) Patent Application Publication
(10) Pub. No.: US 2015/0131818 A1
(43) Pub. Date: May 14, 2015

(54) LOUDSPEAKER

(71) Applicant: HON HAI PRECISION INDUSTRY CO., LTD., New Taipei (TW)

(72) Inventor: CHIH-HUA CHEN, New Taipei (TW)

(73) Assignee: HON HAI PRECISION INDUSTRY CO., LTD., New Taipei (TW)

(21) Appl. No.: 14/095,897

(22) Filed: Dec. 3, 2013

(30) Foreign Application Priority Data
Nov. 8, 2013 (TW) 102140619

(51) Int. Cl. H04R 1/02

(52) U.S. Cl. CPC H04R 1/02
USPC 381/160

(57) ABSTRACT

A loudspeaker includes a circuit board defining a receiving hole, a supporting bracket received in the receiving hole and mounted to the circuit board, a sound-reflecting member, a connecting plate, a sound generator mounted to the sound-reflecting member, and a controller. The supporting bracket includes a hemispherical receiving portion. The sound-reflecting member includes a sound-reflecting plate received in the receiving portion and a number of magnetic pieces extending out from a circumference of the sound-reflecting plate. A number of electromagnets are mounted on the circuit board, and face the magnetic pieces. The connecting plate is slidably engaged with an outer surface of the receiving portion and connected to the sound-reflecting member. The controller is coupled to the electromagnets. The controller controls the electromagnets to attract the magnetic pieces, to allow the sound-reflecting plate to swing.

### BACKGROUND

1. Technical Field

The present disclosure generally relates to a loudspeaker.

2. Description of Related Art

Sound broadcast by loudspeakers broadcasts in all directions. However, the sound may not be heard equally and clearly by people at different locations, and a conventional loudspeaker can not adjust itself towards a listener at a different locations. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a loudspeaker.

FIG. 2 is similar to FIG. 1, but viewed from another perspective.

FIG. 3 is an assembled, isometric view of the loudspeaker of FIG. 1.

FIG. 4 is a cross-sectional view of FIG. 3, taken along the line of IV-IV.

FIG. 5 is similar to FIG. 3, but shows the loudspeaker in a state of use.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one”.

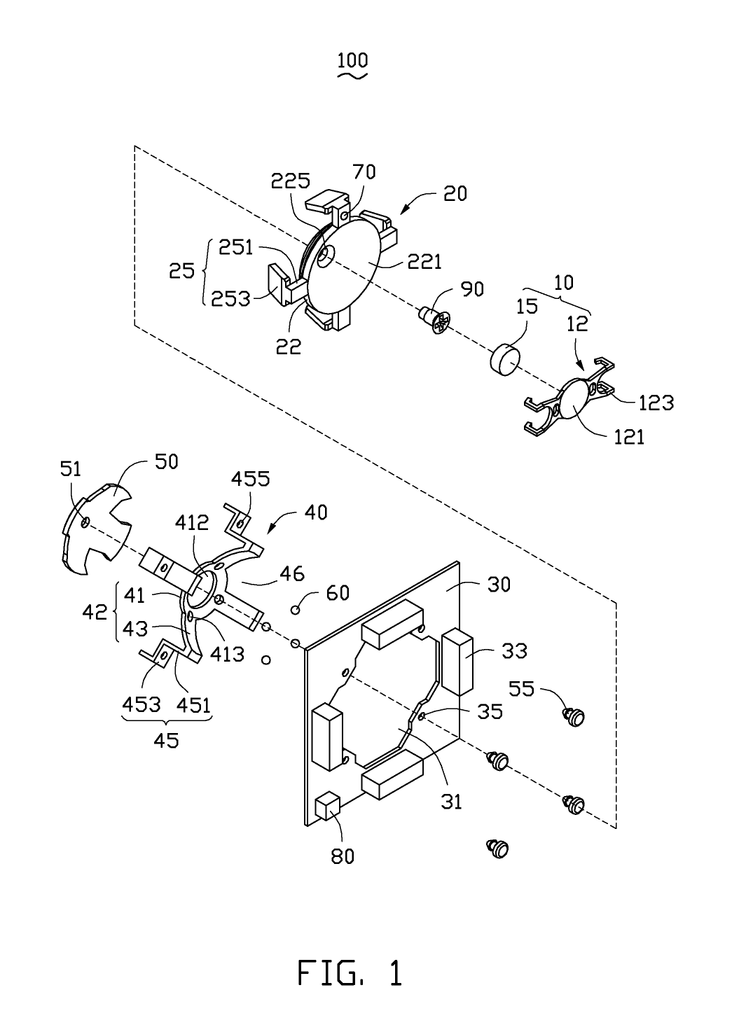

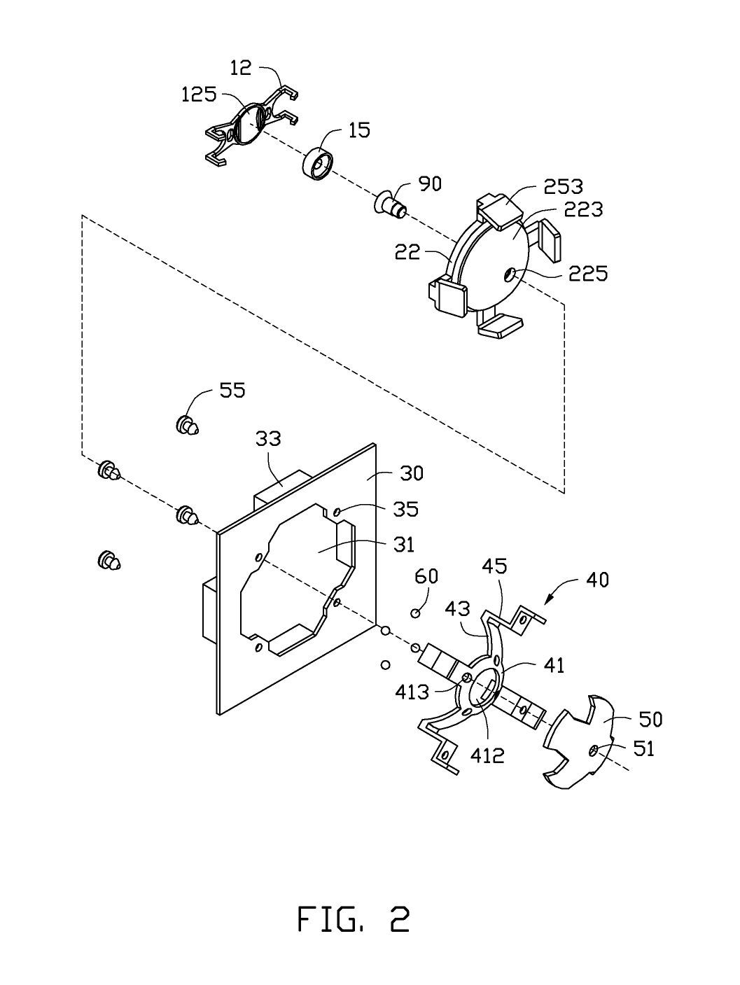

FIGS. 1 and 2 show an embodiment of a loudspeaker 100 including a sound generator 10, a sound-reflecting member 20, a circuit board 30, a supporting bracket 40, a connecting plate 50, a plurality of balls 60, a monitoring apparatus 70, a controller 80, and a fastening member 90.

The sound generator 10 includes a mounting bracket 12 and an electromagnetic actuator 15. The mounting bracket 12 includes a bowl 121 and a plurality of connecting hooks 123 extending out from a circumference of the bowl 121. An inner surface of the bowl 121 defines a latching hole 125 for receiving the electromagnetic actuator 15. The electromagnetic actuator 15 is configured for generating sound.

The sound-reflecting member 20 includes a sound-reflecting plate 22 and a plurality of magnetic pieces 25 extending from a circumference of the sound-reflecting plate 22. The sound-reflecting plate 22 is made of acoustic resistant material. An inner surface of the sound-reflecting plate 22 is a bowl-shaped sound-reflecting surface 221, and an outer surface of the sound-reflecting plate 22 is a hemispherical sliding surface 223 opposite to the sound-reflecting surface 221. An area of the sound-reflecting surface 221 is greater than an area of an outer surface of the electromagnetic actuator 15 opposite to the sound-reflecting surface 221. A middle of the sound-reflecting plate 22 axially defines a through hole 225. Each magnetic piece 25 includes an extending portion 251 extending out from the circumference of the sound-reflecting plate 22 and a magnetic portion 253 slantingly extending rearward from a distal end of the extending portion 251 away the sound-reflecting surface 221. In the embodiment, each magnetic portion 251 is made of iron.

The circuit board 30 defines a receiving hole 31. Four electromagnets 33 are mounted on a front surface of the circuit board 30, and located adjacent a sidewall bounding the receiving hole 31. The circuit board 30 defines four through holes 35 around the receiving hole 31.

The supporting bracket 40 includes a hemispherical receiving portion 42 and four positioning plates 45. The receiving portion 42 includes a bowl-shaped base 41 and four arced supporting plates 43 extending forward from a circumference of the base 41. The base 41 and the supporting plates 43 cooperatively bound a hemispherical adjusting space 46. A middle of the base 41 axially defines a through hole 412. Junctions of the base 41 and the connecting plates 43 define a plurality of mounting holes 413. Each positioning plate 45 is substantially L-shaped, and includes an extending portion 451 extending rearward from a distal end of the corresponding connecting plate 43 and a positioning portion 453 perpendicularly extending out from a distal end of the extending portion 451. The positioning portion 453 defines a latching hole 455.

The connecting plate 50 is hollow and hemispherical, and axially defines a connecting hole 51 in a middle of the connecting plate 50.

The monitoring apparatus 70 is mounted to one of the extending portions 251, and the monitoring apparatus 70 faces the sound generator 10. The monitoring apparatus 70 and the sound reflecting member 20 face a same direction. The monitoring apparatus 70 is configured for capturing images in front of the sound-reflecting member 20.

The controller 80 is mounted on the circuit board 30 and electrically coupled to the monitoring apparatus 70 and the electromagnets 33.

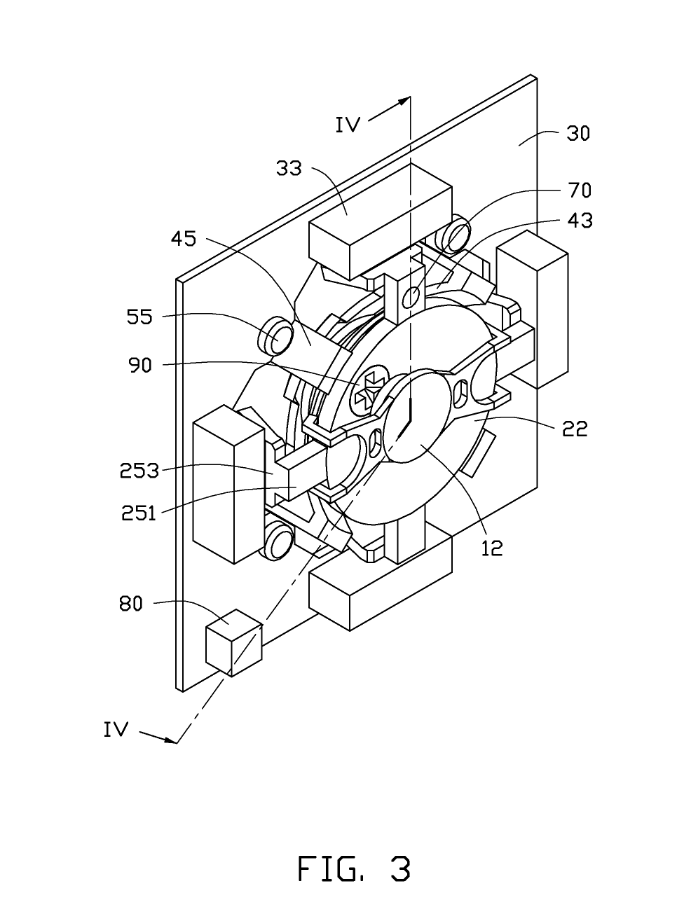

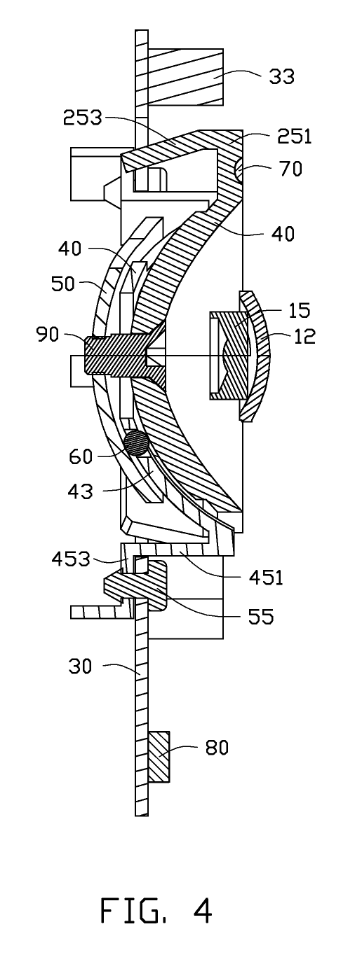

FIGS. 3 and 4 show that in assembling, the loudspeaker 100, the supporting bracket 40 is received in the receiving hole 31 of the circuit board 30. The extending portions 451 are resiliently abutted against the sidewall bounding the receiving hole 31, and the positioning portions 453 of the positioning plates 45 are engaged with a rear surface of the circuit board 30 opposite to the electromagnets 33. The latching holes 455 of the positioning portions 453 are aligned with the through holes 35 of the circuit board 30. A plurality of fastening members 55 extends through the through holes 35 of the circuit board 30, and latches in the latching holes 455 of the supporting bracket 40. The balls 60 are rotatably received in the mounting holes 413 of the supporting bracket 40. The sound-reflecting member 20 is received in the adjusting space 46 of the supporting bracket 40 through the receiving hole 31 of the circuit board 30. The sliding surface 223 is slidably engaged with an inner surface of the receiving portion 42, and the through hole 225 of the sound-reflecting member 20 is aligned with the through hole 412 of the supporting bracket 40. The magnetic portions 253 face the electromagnets 33 of the circuit board 30. The connecting plate 50 is slidably engaged with an outer surface of the supporting bracket 40, to allow the connecting hole 51 to align with the through hole 412 of the supporting bracket 40. The fastening member 90 extends through the through hole 225 of the sound-reflecting member 20 and the through hole 412 of the supporting bracket 40, to be mounted in the connecting hole 51 of the connecting plate 50. Thus, the balls 60 are rotatably sandwiched between the connecting plate 50 and the sound-reflecting member 20. The electromagnetic actuator 15 is installed in the latching hole 125 of the mounting bracket 12. The connecting hooks 123 are latched to the circumference of the sound-reflecting member 20, to allow the electromagnetic actuator 15 to face the sound-reflecting surface 21.

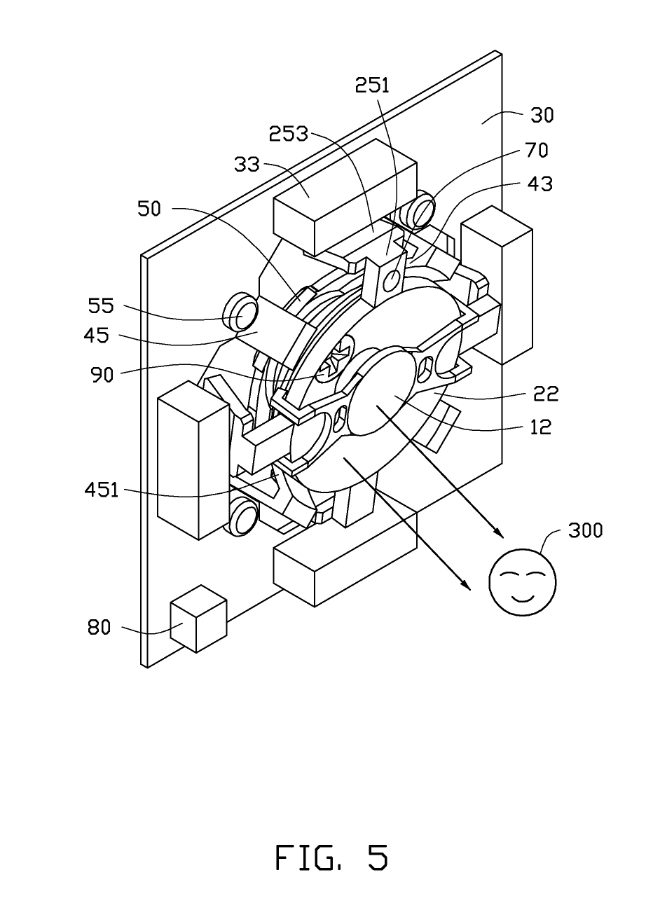

FIG. 5 shows that in use, the sound generator 10 generates sound for a user 300. The monitoring apparatus 70 captures images of the user 300 and transmits the images to the controller 80. The controller 80 recognizes a human face from the images. The controller 80 controls a part of the electromagnets 33 to switch on or off, the magnetic portions 253 are attracted by the electromagnets 33, to allow the sound-reflecting member 20 to swing toward the user 300, such that the sound-reflecting member 20 points to the user 300. The connecting plate 50 is slid along the balls 60 by the sound-reflecting member 20. Therefore, an angle of the sound-reflecting member 20 and the circuit board 30 is adjusted, and the sound generated by the sound generator 10 is mainly broadcasted toward the user 300.

It is to be understood, that even though numerous characteristics and advantages of the embodiment have been set forth in the foregoing description, together with details of the structure and function of the embodiment, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A loudspeaker, comprising:
a circuit board defining a receiving hole, and comprising a plurality of electromagnets mounted on the circuit board;
a supporting bracket received in the receiving hole and mounted to the circuit board, and comprising a hemispherical receiving portion;
a sound-reflecting member comprising a sound-reflecting plate received in the receiving portion and a plurality of magnetic pieces extending from a circumference of the sound-reflecting plate;
a connecting plate slidably engaged with an outer surface of the receiving portion opposite to the sound-reflecting member and connected to the sound-reflecting member;
a sound generator mounted to the sound-reflecting member; and
a controller electrically coupled to the plurality of electromagnets;
wherein the plurality of electromagnets correspondingly faces the magnetic pieces, the controller controls the plurality of electromagnets to switch on or off, the magnetic portions are attracted by the electromagnets, to allow the sound-reflecting member to swing, the connecting plate is slid along the outer surface of the receiving portion, thereby swinging the sound-reflecting member, to adjust an angle between the sound-reflecting member and the circuit board.

2. The loudspeaker of claim 1, wherein the plurality of electromagnets is located adjacent a sidewall bounding the receiving hole of the circuit board.

3. The loudspeaker of claim 1, wherein the plurality of electromagnets is mounted on a front surface of the circuit board, and adjacent to the sound generator.

4. The loudspeaker of claim 1, wherein the receiving portion comprises a base and a plurality of arced supporting plates extending from a circumference of the base, the base and the plurality of supporting plates cooperatively bound a hemispherical adjusting space, the sound-reflecting member is received in the adjusting space, and the connecting plate is engaged with an outer surface of the base.

5. The loudspeaker of claim 4, wherein an inner surface of the sound-reflecting plate is a bowl-shaped sound-reflecting surface facing the sound generator.

6. The loudspeaker of claim 5, wherein an outer surface of the sound-reflecting plate is a hemispherical sliding surface opposite to the sound-reflecting surface, the sliding surface of the sound-reflecting plate is slidably engaged with an inner surface of the receiving portion.

7. The loudspeaker of claim 6, wherein the base axially defines a through hole, the sound-reflecting plate defines a through hole, the connecting plate defines a connecting hole, a fastening member extends through the through hole of the sound-reflecting plate and the through hole of the base, and is fixed in the connecting hole of the connecting plate.

8. The loudspeaker of claim 4, wherein the supporting bracket further comprises a plurality of positioning plates mounted to the circuit board.

9. The loudspeaker of claim 8, wherein each positioning plate comprises an extending portion extending from a distal end of the corresponding supporting plate and a positioning portion extending out from a distal end of the extending portion, the positioning portion is mounted to the circuit board.

10. The loudspeaker of claim 4, further comprising a plurality of balls, wherein the base defines a plurality of mounting holes, the plurality of balls is rotatably received in the plurality of mounting holes of the base, and the plurality of balls is sandwiched between the sound-reflecting plate and the connecting plate.

11. The loudspeaker of claim 1, wherein each magnetic piece comprises an extending portion extending out from the sound-reflecting plate and a magnetic portion slantingly extending from a distal end of the extending portion toward the sound-reflecting plate.

12. The loudspeaker of claim 11, further comprising a monitoring apparatus electrically coupled to the controller, wherein the monitoring apparatus and the sound-reflecting member point to the same direction, the monitoring apparatus is configured for capturing images in front of the sound-reflecting member, and transmits the images to the controller.
